(19) United States
(12) Patent Application Publication
(10) Pub. No.: US 2008/0077602 A1
(43) Pub. Date: Mar. 27, 2008

(54) Database access computer language

(75) Inventors: Rand Warsaw, Monroeville, PA (US); Andrew J. Meyer, Pittsburgh, PA (US); Vijay Parmar, Pittsburgh, PA (US)

Correspondence Address: FOX ROTHSCHILD, LLP, 625 LIBERTY AVENUE, PITTSBURGH, PA, 15222-3155, US

(73) Assignee: WEATHERWISE USA, INC., PITTSBURGH, PA (US)

(21) Appl. No.: 11/303,656

(22) Filed: Dec. 16, 2005

Related U.S. Application Data
(60) Provisional application No. 60/712,544, filed on Aug. 30, 2005.

(51) Int. Cl. G06F 17/30

(52) U.S. Cl. 707/101; 707/E17.001

(57) ABSTRACT

An operating system independent computer language to enable non-technical users to manipulate data from within large pre-existing files or databases with limited involvement of programmers. This language can also be used to distribute the processing for such file manipulations across any group of networked computers.

### CROSS-REFERENCE TO RELATED APPLICATION

This application is based on, and claims priority to provisional application having Ser. No. 60/712,544, having a filing date of Aug. 30, 2005, and entitled Database Access Computer Language.

### FIELD OF THE INVENTION

The invention relates to computer programming languages, and more particularly to computer programming languages that are capable of facilitating access to databases and other stored data by non-programmers.

### BACKGROUND OF THE INVENTION

Many organizations which rely on large stored files of information (often in database form) employ analysts and others who are capable of manipulating data when presented in spreadsheet form, but who require the intervention of a programmer each time they wish to perform large data manipulations. It can be costly for the analyst to first determine what reports or programs are required and then to engage a software programmer to locate the appropriate data within large databases or files (including text or binary) and subsequently write or perform the required tasks. This process can iterate while an analyst determines precisely what is needed and for the analyst to perform “what-if” scenarios.

### SUMMARY OF THE INVENTION

The present invention provides a simple computer language and method which allows an analyst or other end-user to enter commands into a visual-front-end which resembles a familiar spreadsheet. One aspect of the present invention allows the commands entered into the visual-front-end to be interpreted in real time or compiled rapidly and executed in essentially real time, for results to be displayed in a familiar 2-dimensional grid. Another aspect of the present invention would allow the commands to be saved for processing either immediately or at a later time against a larger portion or all of the existing database, databases, file or files. For ease of description, throughout this disclosure Stored data shall be used to mean one or more databases or files. Files can include data, instructions or both. Yet another aspect of the present invention would have the saved commands run in a distributed manner on any or all computers in the network, regardless of the operating system used on the individual computers.

The end-user is not required to have a detailed knowledge of the stored data, nor must the end user necessarily have a license for the database or other program being accessed. Rather, using the invention, a so called “power user,” someone experienced in programming, can create tables or libraries of commands that allow access to existing stored data. The end-user can then use the commands created by the power user as well as the internal language of the invention to analyze data from the stored data. This can be done within the comfort of a visual front-end which simulates, or actually is, a spreadsheet, giving real-time results in a 2-dimensional format.

### BRIEF DESCRIPTION OF THE DRAWINGS

For the purpose of illustrating the invention, there is shown in the drawings a form of the invention that is presently preferred; it being understood, however, that this invention is not limited to the precise arrangements and instrumentalities shown.

FIG. 1 is a schematic overview of a preferred embodiment in accordance with the present invention;

FIG. 2 is a schematic view of the virtual space of the invention depicted in FIG. 1;

FIG. 3 is a schematic view of the file processing of the invention depicted in FIG. 1;

FIG. 4 is a schematic view of the distributed processing environment of the invention depicted in FIG. 1;

FIG. 5 is a schematic view of operating the distributed processing over a networking system of the invention depicted in FIG. 1;

FIG. 6 is an alternate view of operating the distributed processing over an networking system;

FIGS. 7 and 8 are screenshots of the visual front end of the invention depicted in FIG. 1;

FIG. 9 shows one preferred implementation of the present invention in use in a legacy system;

FIG. 10, shows a typical billing print stream of the implementation depicted in FIG. 9;

FIGS. 11 and 12 show schematics of tables of the implementation depicted in FIG. 9;

FIG. 13 shows a beginning of the computer language from the user interface of the implementation depicted in FIG. 9;

FIG. 14 shows a modified print stream generated by the internal calculation engine of the implementation depicted in FIG. 9;

FIG. 15 shows accounting entries of the implementation depicted in FIG. 9;

FIG. 16 shows a generation for a General Ledger of the implementation depicted in FIG. 9; and

FIG. 17 shows entries for a customer history table of the implementation depicted in FIG. 9.

FIG. 18 shows an embodiment of the internal language used to transfer commands between the user interface and the calcualtional engine.

### DETAILED DESCRIPTION OF THE INVENTION

The invention is best understood from the following detailed description when read with the accompanying drawings.

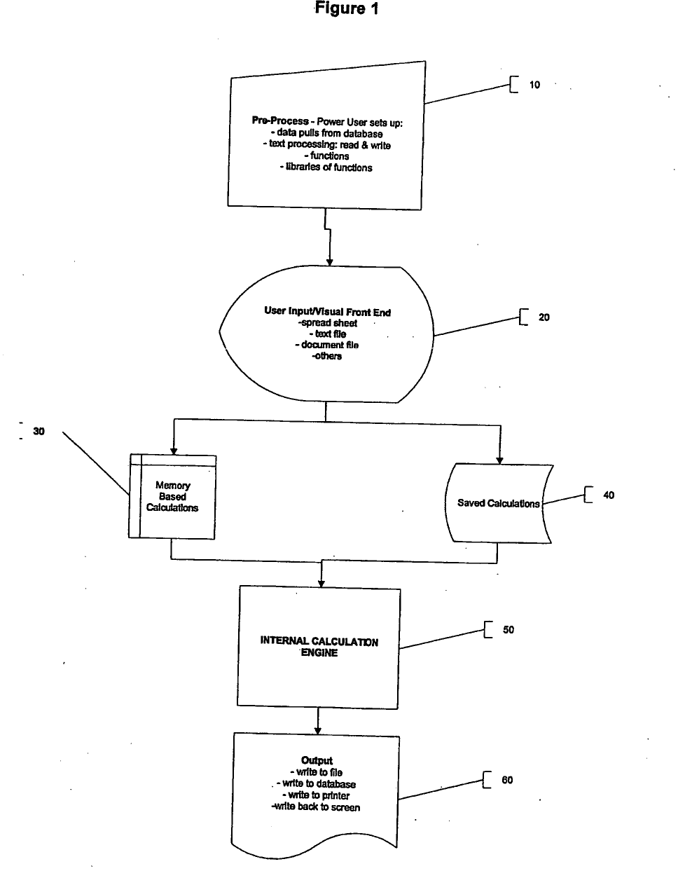

In FIG. 1 there is shown one form of the invention that is presently preferred. The invention comprises a system wherein a power user sets up instructions and/or a library of functions or commands including, among other things, a database and other file access information required to retrieve stored data 10. This library, which may be edited by the power-user at any time, can be set up prior to an end-user accessing the system. The end-user enters functions and/or commands in the syntax of the language. Alternatively, the pre-programmed functions may be entered by the power user into the visual front-end 20 which simulates a 2-dimensional spreadsheet.

The calculations are either parsed and interpreted by the Internal Calculation Engine 50 or compiled and executed in essentially real time, and the results are stored in memory 30. Real-time results are displayed within the visual front-end 20 or the results may be saved. The results of the Internal Calculation Engine's run against the stored data 10 are then output to a designated output 60, which may be a text file, any of the data storage locations, a printer, back to the visual front end 20 or the like.

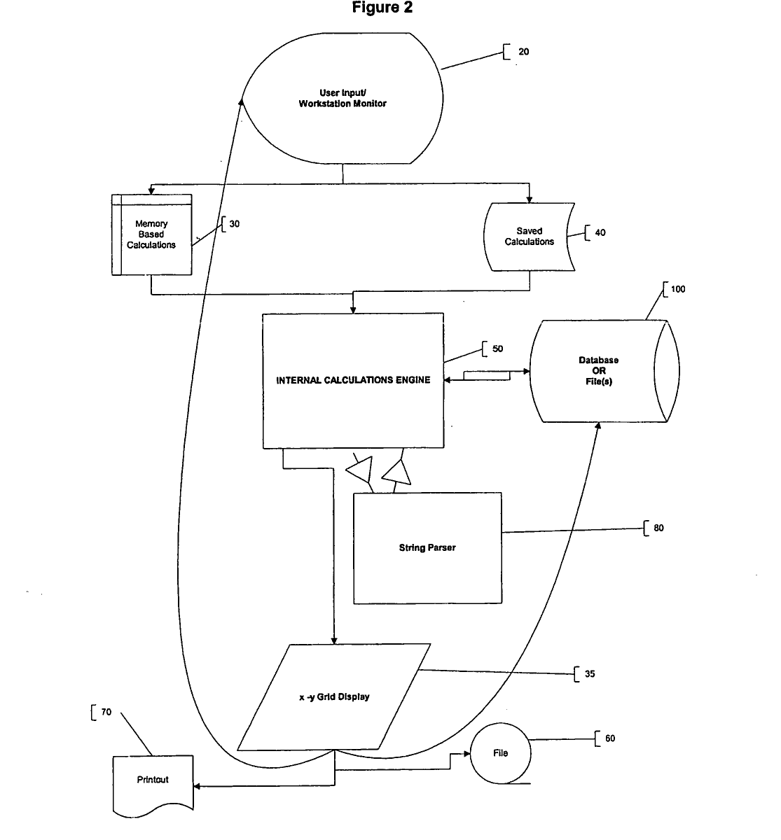

Turning now to FIG. 2, the occurrences within the invention in virtual space are depicted, subsequent to the user inputting commands or functions into the visual spreadsheet front end 20. These commands or functions are parsed by a String Parser 80 and, interpreted and run by the Internal Calculation Engine 50. The commands may also be saved after input 40, for future parsing by the String Parser 80, and/or interpretation and running by the Internal Calculation Engine 50. The results are written to a file 60, printer 70, stored data location, including a database, 100, the x-y grid 35 and displayed on visual front end 20, stored in memory 30 for further calculations or the like.

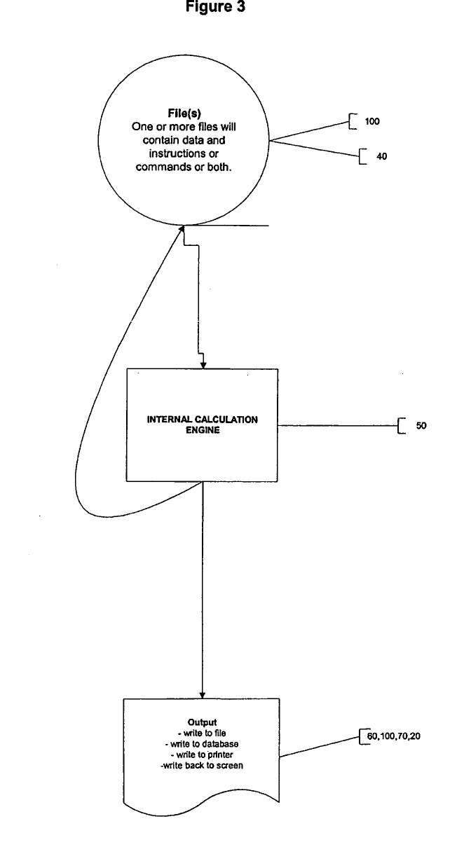

FIG. 3 depicts an aspect of the current invention in which the data to be processed 100, and the instructions to carry out the processing 40, are contained in one or more existing files (stored data) 100, which is then processed by the Internal Calculation Engine 50. The Internal Calculation Engine 50 returns results either to the file(s) 40 or to any other output medium including a database.

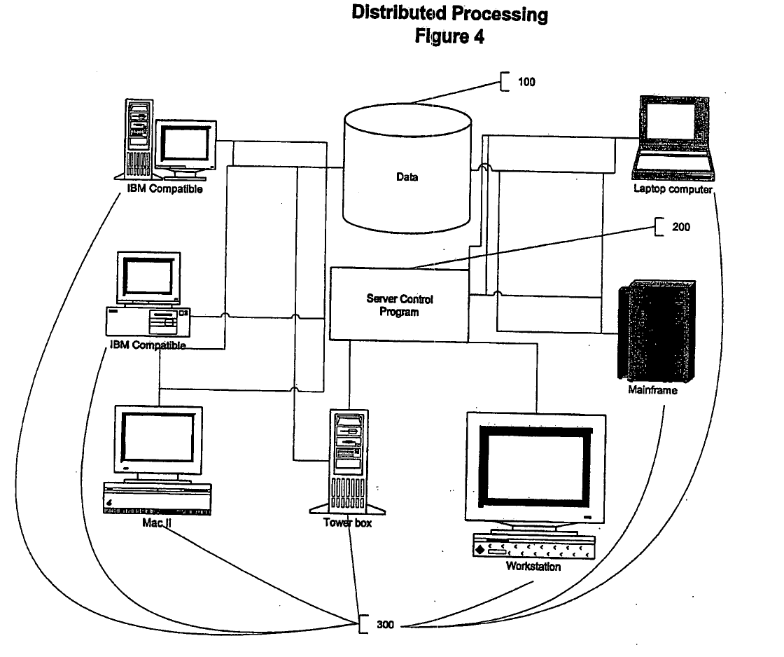

A distributed processing environment is depicted in FIG. 4 in which the invention can be run. A Server Control Program 200 dictates or is told which of the computers 300 on the network are available for running some portion of the saved commands against the stored data 100.

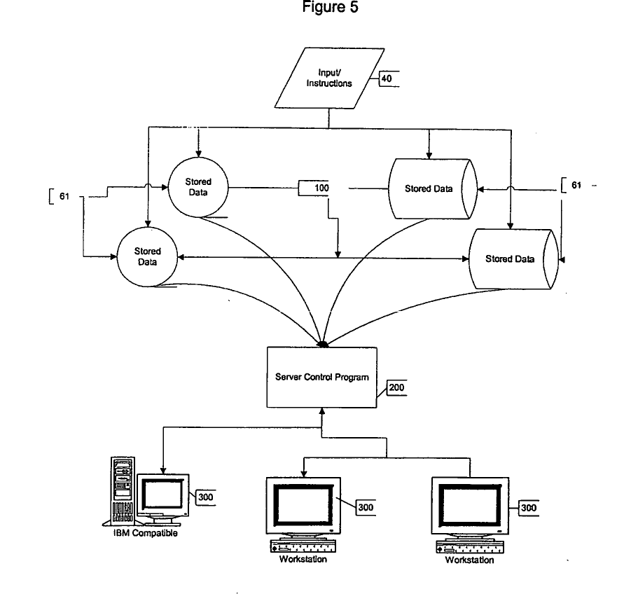

In FIG. 5 there is depicted a method of using the invention to distribute processing of a simulation, e.g., Monte-Carlo, across a network. A user writes instructions 40 which are stored in one or more files (including database files) as stored data 100, which may or may not be the same as the stored data used to provide data against which the instructions are run. Data and instructions from the stored data 100 are distributed to the computing environment via the Server Control Program 200 where one or more computers 300 perform the calculations necessary to perform the saved instructions 40. The results 61 are sent to and tabulated within the stored data 100.

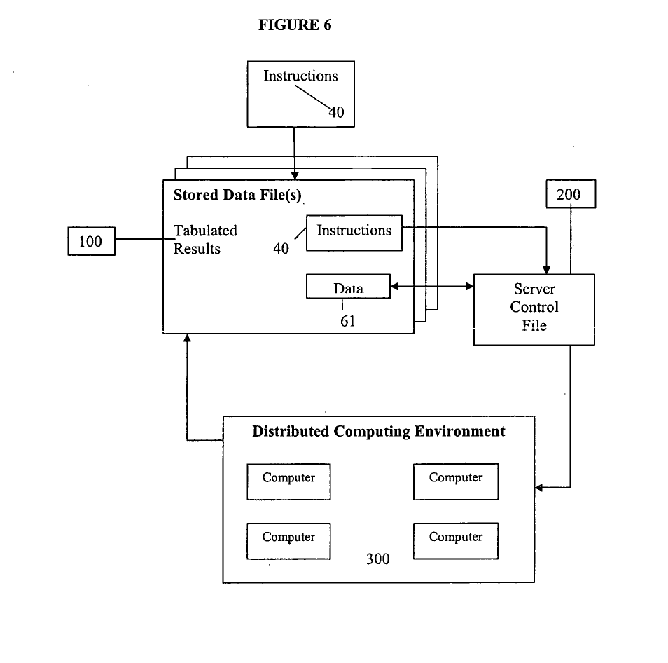

FIG. 6 is an alternate view of FIG. 5 in a more classical depiction.

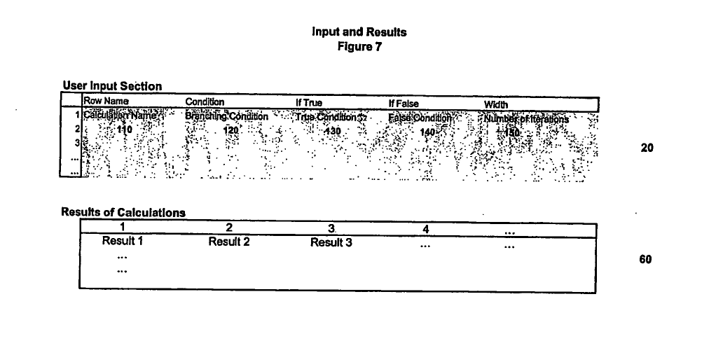

FIG. 7 is a screenshot and depicts a sample input 20 to and output 60 from the present invention. The input simulates a traditional spreadsheet and, in fact, a spreadsheet program may be used to input the data. However, it should be understood that other formats are also contemplated. The ROW name 110 is a label for an individual line of code. The Condition column 120 is a branching command or nested set of commands. The If True column 130 is a command or nested set of commands to be executed if the Condition in the Condition column 120 is true. The If False column 140 is a command or nested set of commands to be executed if the Condition in the Condition column 120 is false. The Width column 150 represents the number of iterations of this calculation which are to be performed. Subsequent row calculations may refer to individual results 60 from prior row calculations as if a reference in a formula in a spreadsheet cell.

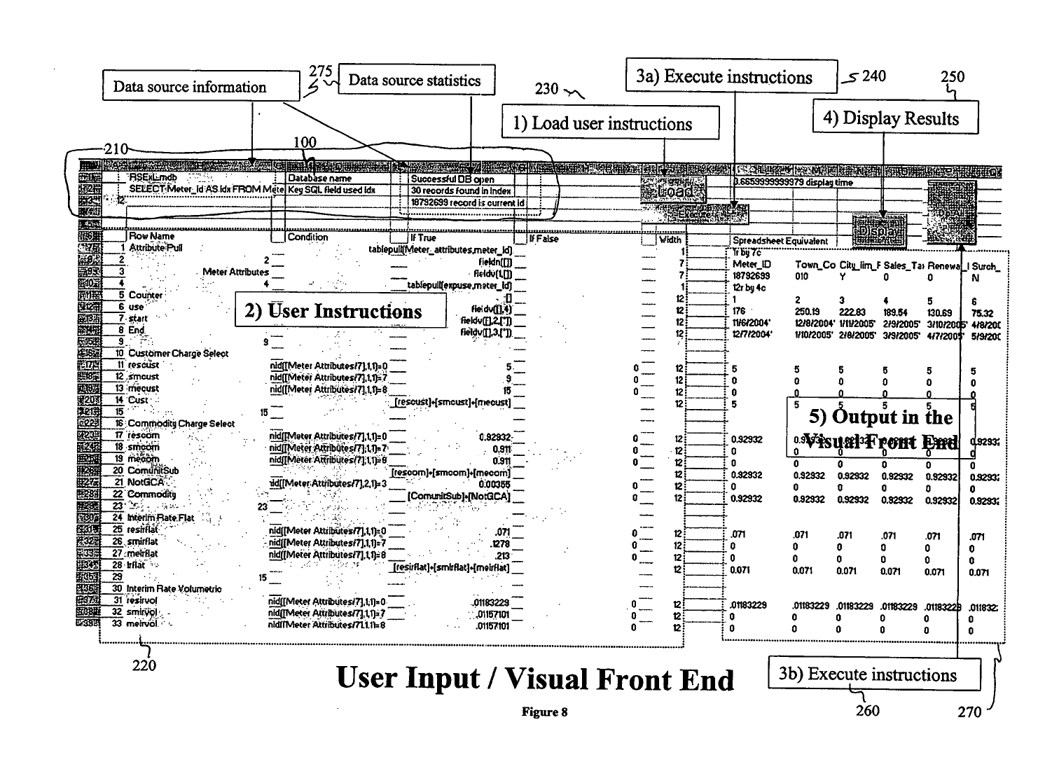

FIG. 8 is a screen shot of the visual front end of the system in one embodiment. The stored data 100 and various other information regarding the stored data 275 are identified in the upper portion of the screen shot 210. Sample rows of input user instructions 220 are shown in the lower left side of the screen shot. Buttons that can be used to perform various functions within the invention are displayed including: Load 230, which loads the user instructions 220 from the stored data 100; Execute 240 which executes the user instructions 220 on the loaded source data 275; Display 250 which displays the results of executing 240 the user instructions 220 on the loaded source data 275; and Do All 260 which executes the instructions on entire selected portion of the stored data 100 rather than just on a selected sample dataset. The results of the Execute 240 command are displayed on the computer monitor 270 if the user chooses to execute the Display 250 command.

Having described the various components of the present invention, we now turn to the operation of the invention. The present invention is an operating system independent computer language which presents a visual front-end to an end-user on a computer monitor or the like which simulates or a spread sheet format which is more familiar to the user. The end-user creates a set of commands within this visual front-end, which are parsed and interpreted real-time against a limited set of data from an existing set of stored data. This process may be iterated as many times as the end-user desires or as often as the commands require in order to obtain the set of commands which produce the desired result. The end user can also save the commands, which can then be run against a larger portion or all of the database, or be worked on at a later time. Further commands or instructions may be stored within the stored data either in stand-alone files or intermingled with the data upon which the data upon which the commands are to be run.

Although exemplary embodiments of the present invention will generally be described in the context of Microsoft Windows, Visual Basic, Oracle and Excel, those skilled in the art will recognize that the present invention can also be implemented in conjunction with other operating systems, high level languages, proprietary databases and spreadsheets for other types of computers and computing systems. Furthermore, those skilled in the art will recognize that the present invention may be implemented in a stand-alone or in a distributed computing environment. In a distributed computing environment, processing of the saved commands may be accomplished on computers located in physically different locations or clustered in one location with different hardware and operating systems. Execution of the programs created within the language may occur locally in a stand-alone manner or remotely in a client/server manner. Examples of such distributed computing environments include local area networks of an office, enterprise-wide computer networks, and internet solutions.

Because of the ability to run commands in a distributed environment, the invention is ideal for running complex simulations requiring extensive computer time. Complex simulations, e.g., Monte-Carlo simulations, often require extensive access to data and large amounts of computing time. Using the distributed computing aspect of the invention, such complex simulations can be run more efficiently.

The invention herein is represented largely in terms of high-level computer languages, processes and symbolic representations of operations by conventional computer components, including processing units, memory storage devices, display devices and input devices. These processes and operations may utilize conventional computer components in a distributed computing environment, including remote file servers, remote computer servers, and remote memory storage devices. Each of these distributed conventional computing components is accessible by a processing unit via a communications network.

The present invention includes a computer language and system which embodies the functions described herein and is illustrated in the appended flow charts (or logic flow diagrams). However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text, for example. Therefore, the particular set of program code instructions does not limit the scope of the present invention. The inventive functionality of the claimed computer language will be explained in more detail in the following description in conjunction with the remaining figures illustrating the program flow.

Although the language includes some basic arithmetic and related commands, database access requires that before an end-user uses the commands, a power-user (a programmer or database administrator) must create a library of commands which allow the end-user to have access to an existing file or files (including database files). These commands are programmed in whatever language the power user is most comfortable using to access existing databases to which the power user will be giving the end user access. In order to successfully access the various file types, read functions (or database pulls) that would allow the end-user to retrieve information from the files (or databases) must be created by the power user. Additional commands could include, without limitation, file or database manipulations and file or database writes.

The visual front-end presented to the end-user on the monitor of a computer can be any file type from a simple text file to an actual spreadsheet. The system will present results either in a spreadsheet format or with the appearance of a spreadsheet, a familiar environment in which the end user can function.

The Internal Calculation Engine is an interpreter (or a compiler and execution in essentially real time) which first calls a string parser to parse commands input from the visual front end or stored in data files. It is an important aspect of the invention that the parser returns strings which can initiate commands from a library that return numerical values as is often done with parsers, reference individual results from prior command steps, reference data elements in a database and perform mathematical calculations. Thus, the function of the string parser is to return the innermost command for processing by the Internal Calculation Engine. The processing by the Internal Calculation Engine may include resolution of simple mathematical functions or string functions which are included within the Internal Calculation Engine or it may involve calling the table of commands that was created by the power user in order to retrieve a value based upon that command. Once the Internal Calculation Engine has resolved the innermost calculation, it calls the String Parser with the result from the innermost calculation in place of that string that was returned from the String Parser in the previous iteration, until a final value for the entire command is retrieved, parsed, and resolved.

The Internal Calculation Engine places the results of running the commands in a virtual spreadsheet for storage and for possible presentation to the end-user as the result of the real-time running of the Internal Calculation Engine. The virtual spreadsheet may also be saved for later presentation or for incorporation into the original saved data.

As previously stated, it will be obvious to a person skilled in the art of computer programming that the database or databases can be in any database program, including Oracle or Microsoft Access. Text files can be in any format. Similarly, the visual front-end can be displayed in any format which will display the data to the end-user including simple text, a word processor, or a spreadsheet.

The following is one preferred operative example of a preferred implementation of the present invention. It should be understood that many other implementations are contemplated by the present invention and fall within the scope thereof.

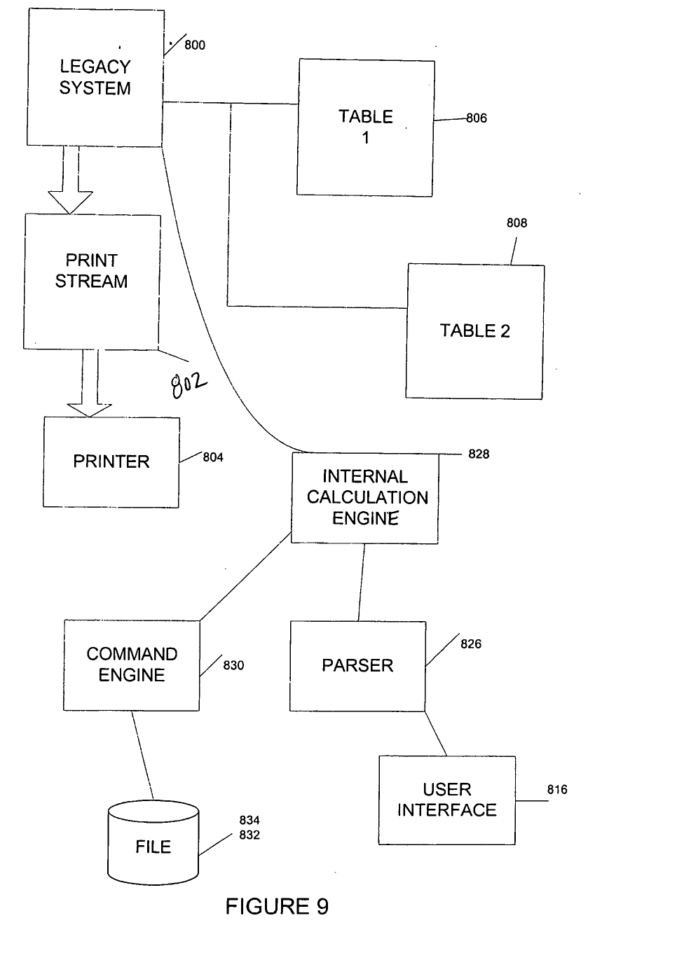

In FIG. 9 there is shown a legacy computer system 800 for a business, such as a natural gas distribution company. Typically, legacy systems in use today may be as old as 30 years or more. By legacy it is meant that the current management did not necessarily build the system, and may not completely understand the system, but relies on the operation of the system for efficient operations of the business. Moreover, legacy systems typically have been patched repeatedly for changes in the business model that have occurred over the operating life span of the system. As a result, the business model becomes dependent upon the flaws in the legacy system. For example, a legacy system may include a billing and customer information system. Over time, the business model of the system becomes so tied to the limitations of the billing and customer information systems that the two major attributes of the business, the systems and the business model become codependent. Thus, when gas companies update systems to new modern hardware and software, the nuances, such as existing shortcomings and flaws, of the legacy systems are replicated.

Not surprisingly, legacy systems are expensive and difficult to program. Since they have been patched for over tens of years, they are like suits that have been over-repaired by a tailor. If you pull out a thread in the arm, the back could fall off. Given this interdependence of repairs and operations, modification of the billing system, testing and repairing the unknown effects of the modification is often much more expensive than the original modification. Additionally, these antique systems are often written in antique programming languages, so finding programmers is difficult, if not impossible. In some systems, it may be easy to add a new table, but difficult to tie the logic of items contained in the new table to the billing system programming.

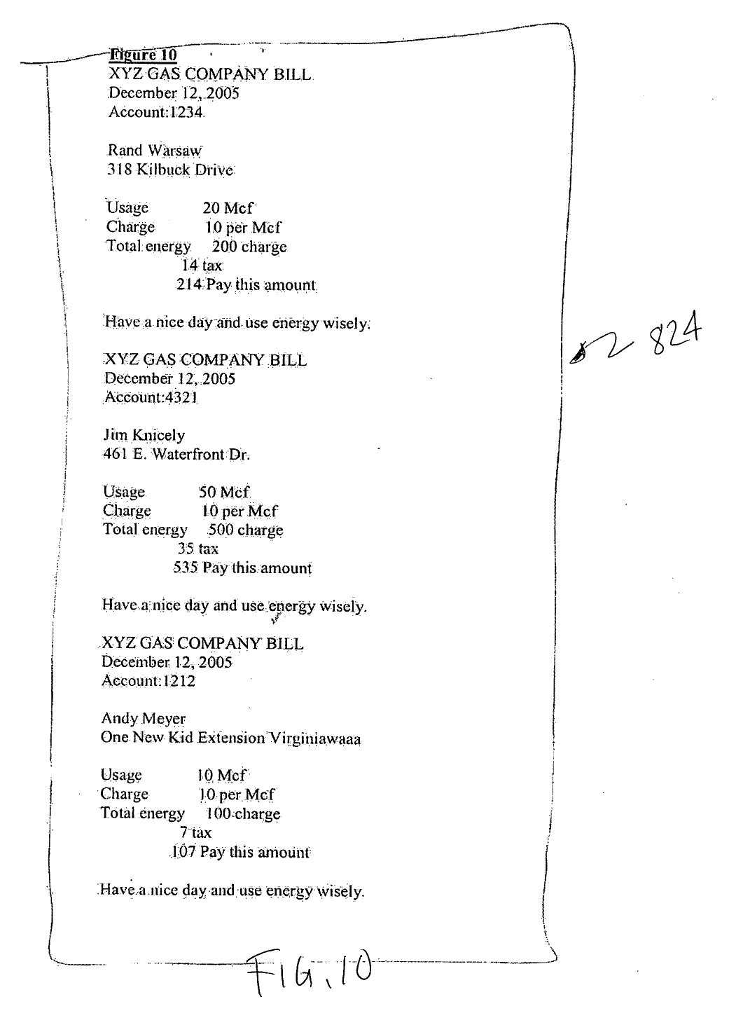

In FIG. 10, there is depicted an example of a portion of a typical billing print stream from a billing system 824 of the legacy system. The bill print stream 802 is captured by the present invention before it goes to a printer. The bill print stream 802 is in the form of a block of characters that looks like the bill with special printer control added thereto. It should be understood that other forms are contemplated by the invention, such as binary forms. The print stream is in the form of a text file. Most large firms have the capability of intercepting such a bill print stream before it is passed to a printer 804, as shown in FIG. 9.

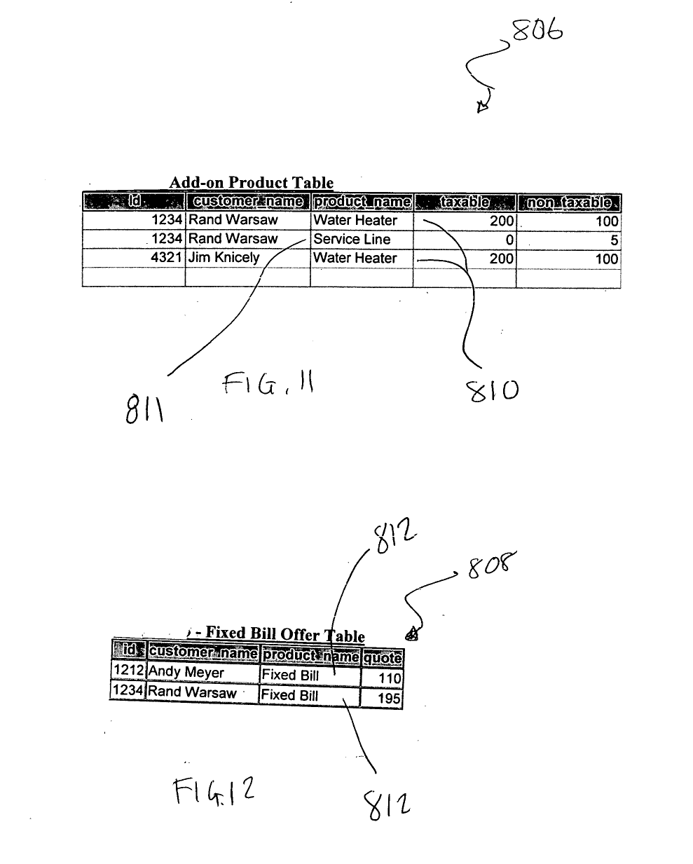

The present invention is implemented by adding two new tables 806 and 808 to the legacy system 800. A schematic of the first table 806 is depicted in FIG. 11 and contains add-on products of a water heater 810 and a service line warranty 811. These add-ons did not exist at the time that the legacy system was originally placed into service; however, present day realities necessitate that these add-ons be implemented in the customer billing scheme. When consumers of the gas company sign up for these products, they are added to these tables by any suitable method known to those skilled in the art.

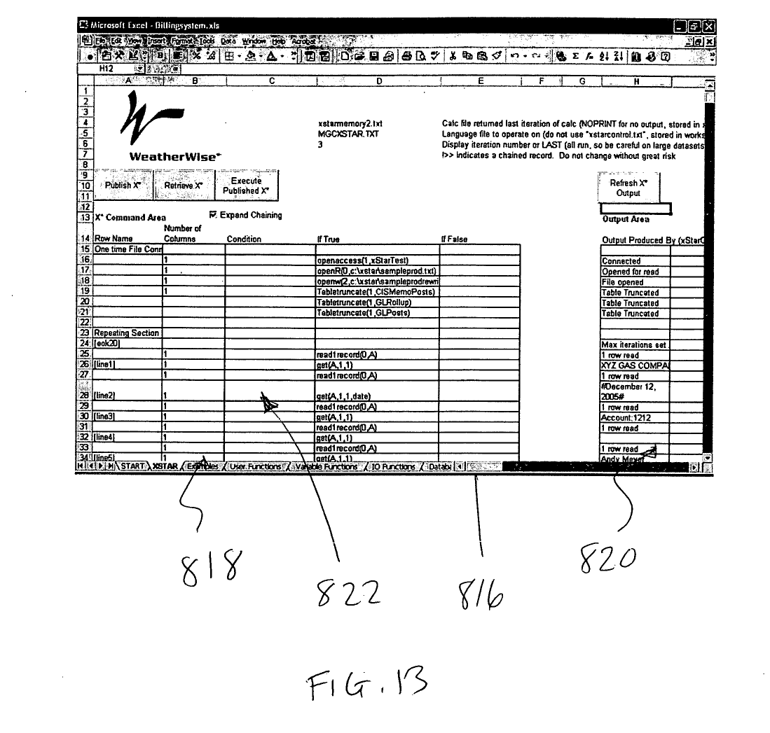

A schematic of the second table 808 is depicted in FIG. 12. The second table 808 contains fixed bill products 812. These products are volume independent offers to supply energy. As before, these fixed bill products did not exist when the legacy system was originally implemented.

In FIG. 13, there is depicted the beginning of an embodiment of the computer language from the user interface 816. As can be seen, the left section 818 contains the commands and the right section 820 contains the grid that displays the results in a spreadsheet like manner.

The present invention permits a user to debug the code in the interface 816 and then sets the code 822 to operate on the entire data set of the print stream 802. In this example, the entire data set 802 of three consumers 824 is run.

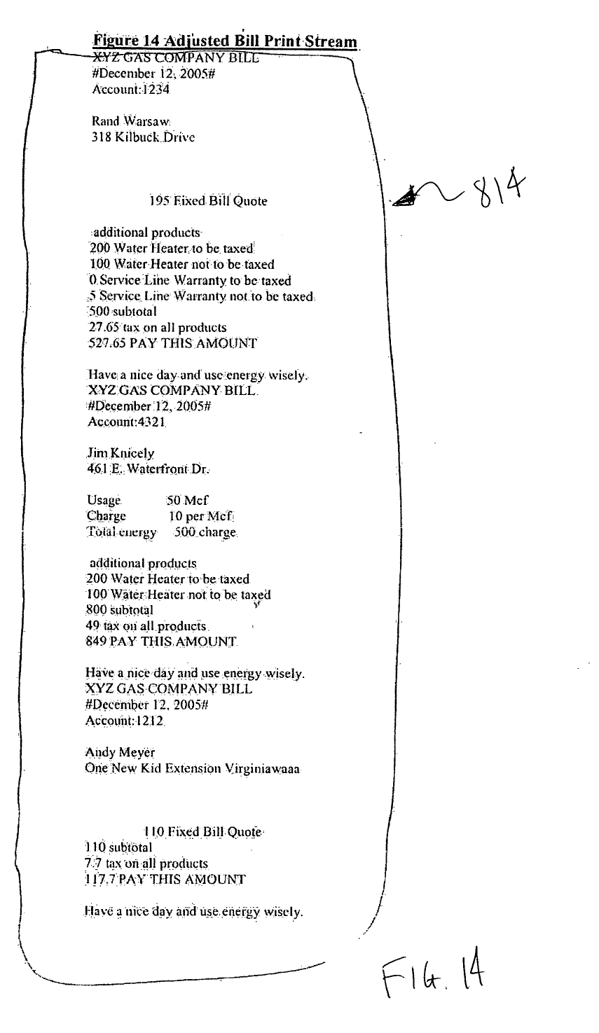

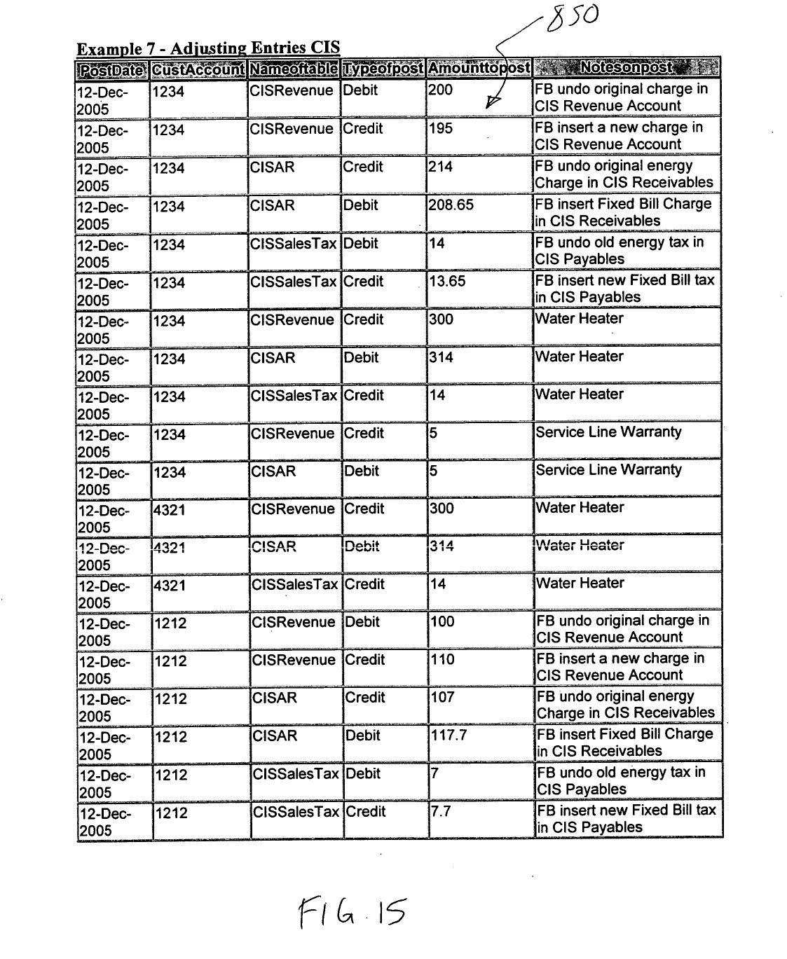

The interface 816 generates the language that the parser and internal calculation engine use. An example of this language 822 is depicted in FIG. 13. The parser 826 and the calculation engine 828 interpret the language. The command engine 830 opens files 832 and extracts data from the files, opens databases 834 and queries examples in databases to acquire the necessary data for the calculations required by the language to modify the bills. In FIG. 14, there is shown a new print stream 814 which has been generated by the internal calculation engine 830 in a new file. This new file contains the modifications desired by the consumers and the business entity.

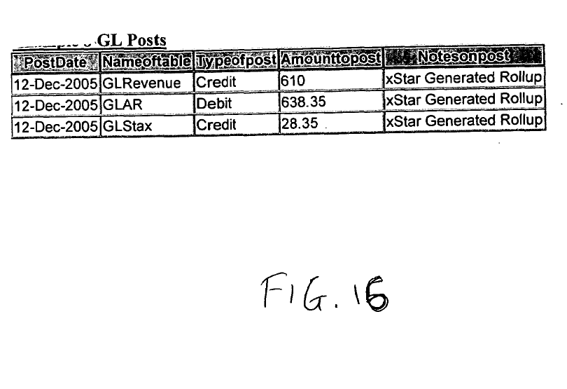

In FIG. 15, there are depicted accounting entries 850 that can be entered either manually or automatically in the consumers' accounts. These entries 850 were also generated by the internal calculation engine and parser interpreting the language and were based on user specified rules.

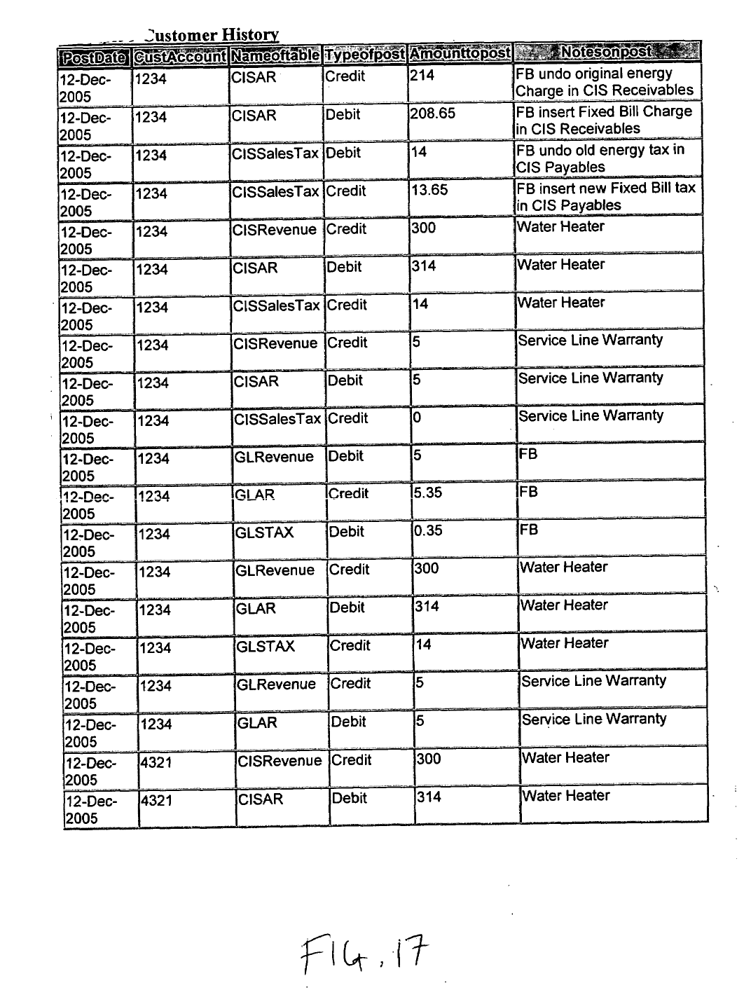

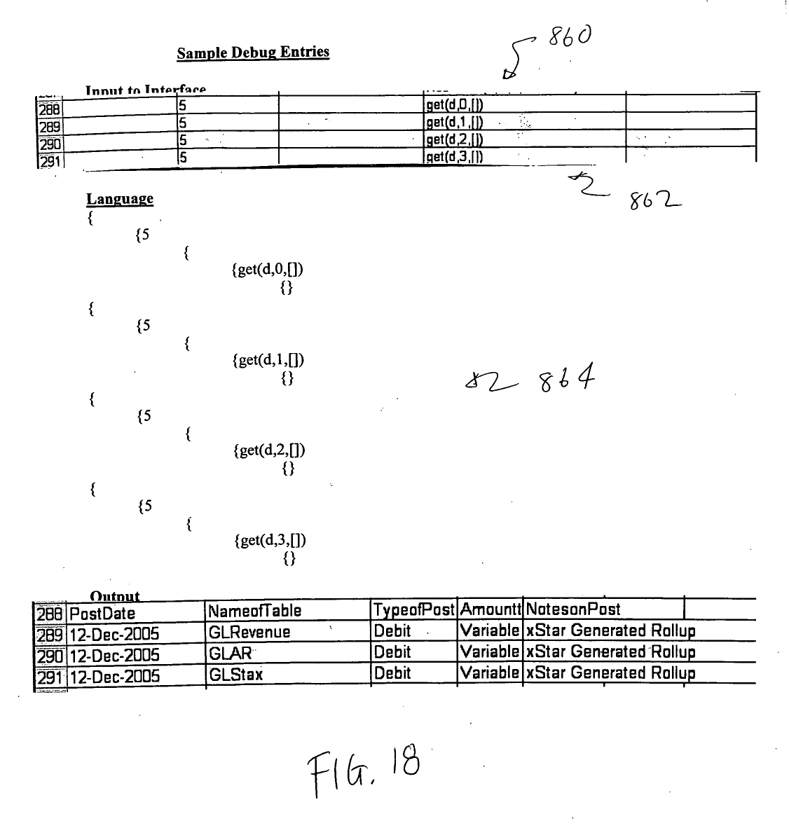

In FIG. 16, there is depicted a similar generation for the General Ledger that can be used by the business entity. In FIG. 17, similar entries for a customer history table can optionally be added to the system.

In FIG. 18, a portion 860 of the user interface entries of the calculation is shown. This portion shows the power of the grid in development. The lines 862 replicate a portion of a table in a grid manner. The language 864 generated by the interface is shown below the input. After the parser and the internal calculation engine operate on the data, the results can be shown as an x-y grid table in the interface. Thus, the present invention permits, by use of this feature, the modification of a complicated legacy system in a drastically shorter period of time than it would have taken to modify the legacy system directly using known methods. For example, the preferred implementation may take about 6 hours; in contrast, it may have taken, tens, hundreds or thousands of hours with traditional methods.

The present invention may be embodied in other specific forms without departing from the spirit or essential attributes thereof and, accordingly, reference should be made to the appended claims, rather than to the foregoing specification, as indicating the scope of the invention.

What is claimed is:

1. An operating system independent computer language presenting results as a spreadsheet comprising:
a library of at least one function used to access and manipulate an existing file of stored data;
a visual front end emulating a spreadsheet from which an end-user enters a command, which can include a function;
an internal calculation engine which is called from the visual front end to interpret or real-time compile and execute the command;
a string parser used by the internal calculation engine to parse the command from the visual front end into at least one function call; and
a result from the internal calculation.

2. The computer language of claim 1 wherein the result is delivered to at least one medium selected from the group consisting of an existing file of stored data, a new file of stored data, the visual front-end, a result database or a temporary internal memory location.

3. The computer language of claim 2 wherein the result database includes a plurality of the existing files of stored data.

4. The computer language of claim 2 wherein the existing file of stored data is a database.

5. The computer language of claim 4 wherein at least one of the databases is in a proprietary format selected from the group consisting of: Oracle, Microsoft Access, DBII, Microsoft SQL Server, My SQL, Postgre SQL, Foxbase, Foxpro, Btrieve, Filemaker, Ingress, Firebird, MaxDB, Open Office Base, and Sybase.

6. The computer language of claim 2 wherein the existing file of stored data is a text file.

7. The computer language of claim 2 wherein at least one of the existing file of stored data is a binary file.

8. The computer language of claim 2 wherein the visual front end is displayed in a proprietary spreadsheet format selected from the group consisting of: Microsoft Excel, Lotus 1-2-3, Quatro, Microsoft Works Claris Works and Open Office Calc.

9. The computer language of claim 2 wherein the visual front end is a plain text file.

10. The computer language of claim 2 wherein the visual front end is a word processing document.

11. The computer language of claim 10 wherein the word processing document is in a proprietary format selected from the group consisting of: Microsoft Word, Microsoft Works, Claris Works, Open Office Writer, or Word Perfect.

12. An operating system independent method of allowing a user with little or no programming knowledge to perform complex operations on a database or other text file comprising:
one or more functions being input into a library, such functions to include links to one or more existing files of stored data;
an end user creating a sequential set of one or more commands, including the functions, from within a visual front end which presents results as a spreadsheet, said commands to access or manipulate data from the one or more existing files of stored data;
interpreting the commands using an internal calculation engine combined with a string parser;
running the commands on data from the one or more files of stored data; and
returning a set of results to the end user.

13. The method of claim 12 wherein the set of results is delivered to at least one medium selected from the group consisting of an existing file of stored data, a new file of stored data, or a temporary internal memory location in addition to or in place of being returned to the end user.

14. The method of claim 13 further comprising a next step selected from the group consisting of editing the commands, saving the commands and running the commands against a larger subset of data from the files of stored data.

15. The method of claim 13 wherein at least one of the existing files of stored data is a database.

16. The method of claim 15 wherein at least one of the databases is in a proprietary format selected from the group consisting of: Oracle, Microsoft Access, DBII, Microsoft SQL Server, My SQL, Postgre SQL, Foxbase, Foxpro, Btrieve, Filemaker, Ingress, Firebird, MaxDB, Open Office Base, and Sybase.

17. The method of claim 14 wherein at least one of the existing files of stored data is a text file.

18. The method of claim 14 wherein at least one of the existing files of stored data is a binary file.

19. The method of claim 14 wherein the visual front end is displayed in a proprietary spreadsheet format selected from the group consisting of: Microsoft Excel, Lotus 1-2-3, Quatro, Microsoft Works, Claris Work, and Open Office Calc.

20. The method of claim 14 wherein the visual front end is a plain text file.

21. The method of claim 14 wherein the visual front end is a word processing document.

22. The method of claim 21 wherein the word processing document is in a proprietary format selected from the group consisting of: Microsoft Word, Microsoft Works, Claris Works, Open Office Writer, or Word Perfect.

23. The method of claim 14 wherein the saved commands are run against the one or more files of stored data through distributed processing across a network.

24. The method of claim 23 wherein the distribution across the network is optimized by a server control program.

25. The method of claim 23 wherein the distribution across the network is chosen by the end user.

26. The method of claim 23 wherein the saved commands facilitate a simulation to a computer or distributed computer environment.
